(19) United States
(12) Patent Application Publication
(10) Pub. No.: US 2010/0119651 A1
(43) Pub. Date: May 13, 2010

(54) Bio-Enzyme-Assisted Extraction Method for Inulin

(76) Inventors: Shufeng Fan, Nanjing (CN); Juan Liu, Nanjing (CN); Zhuo Wang, Nanjing (CN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/612,844

(22) Filed: Nov. 5, 2009

(30) Foreign Application Priority Data
Nov. 12, 2008 (CN) 200810234361.7

(51) Int. Cl. A23L 1/03

(52) U.S. Cl. 426/50

(57) ABSTRACT

A bio-enzyme-assisted extraction method for inulin is disclosed. The method comprises extracting pretreated dry powder of Jerusalem artichoke using a hot water extraction method to obtain a crude extract of inulin, treating the obtained extract of inulin by decoloring, removing impurities, purifying with an ultrafiltration membrane, vacuum concentrating, and spray drying to obtain inulin. The dry powder of Jerusalem artichoke is soaked with a pH 4-5.5 HAc—NaAc buffer solution prior to hot water extraction, and cellulase and pectinase of 0.1-0.5% wt are added in the buffer solution during soaking. The mass ratio of cellulase and pectinase is 1:1-3:1, and the dry powder is soaked at 40° C.-55° C. for 0.5-1.5 hours. The present invention solves the disadvantages in prior art, such as low extraction rate, long extraction time, and high energy consumption during water bath extraction. The present invention also provides a bio-enzyme-assisted extraction method for inulin having the advantages of high extraction rate and short water bath extraction time.

### CROSS REFERENCE TO RELATED APPLICATIONS

This application claims priority to co-pending Chinese Patent Application No. CN 200810234361.7 entitled “Bio-Enzyme-Assisted Extraction Method for Inulin”, filed Nov. 12, 2008.

### FIELD OF THE INVENTION

The present invention relates to an extraction method for inulin, and particularly relates to a bio-enzyme-assisted extraction method for inulin.

### BACKGROUND

Inulin is a linear polysaccharide formed by linking D-fructose connected by a β-(2,1)glycosidic bond, and usually contains glucosyl at its end. Its degree of polymerization (DP) is about 2-60. Inulin is a nondigestible hydrocarbon, which can selectively promote growth of colon bacteria to improve the health of a host. Additionally, inulin also can reduce the concentration of blood sugar, maintain the balance of the lipid metabolism, increase bioavailability of mineral elements, and enhance immunity. In the food industry, inulin, which belongs to functional food, can improve food texture, rheological properties, and nutrition characteristics. Inulin, as a natural functional food adjuvant, has been widely applied in European countries and America.

China has entered into the technical field of inulin extraction only since the late of 1990s, so the technology is still under development and is not mature. The extraction and separation process of inulin usually comprises: pretreatment-extraction-impurity removal and decolorization-sterilization by membrane filtration-spray drying.

The extraction method typically includes a hot water extraction method, which carries out extraction by soaking a pretreated Jerusalem artichoke used as raw material under heat with water as a solvent for a certain time. The microwave method carries out extraction by utilizing microwaves to raise material temperature via polarization, friction, and collision of the molecules. The ultrasonic method adopts ultrasound. A and combination of those methods is also used. The hot water extraction method is most frequently used. In industrial production, Jerusalem artichoke extractive solution is subjected to deashing and decoloring, is sterilized by filtering with filtration membrane, is purified by ultrafiltration membrane, and then is converted into a sterile powder of Jerusalem artichoke via spray drying. The extraction method adopted at the key extraction stage of the process available now has a low extraction rate (only about 50%). Common hot water extraction requires extracting at 80° C. for 0.5 hours, which has high energy consumption.

### SUMMARY

To solve the disadvantages in the prior art, such as low extraction rate, high energy consumption, and long extraction time of water bath extraction, the present invention provides a bio-enzyme-assisted extraction method for inulin, with the advantages of high extraction rate and short water bath extraction time.

The technical scheme of the present invention is a bio-enzyme-assisted extraction method for inulin, which comprises the following steps:

(1) Adopting Jerusalem artichoke as a raw material, cleaning and slicing fresh Jerusalem artichoke, performing heat treatment by blanching with hot water to deactivate the polyphenol oxidase in the Jerusalem artichoke, and drying to obtain dried slices of Jerusalem artichoke; wherein blanching at 80° C.-100° C. for 5-20 minutes (min.) and drying is performed at 40° C.-75° C. for 3-9 hours (h);

(2) Pulverizing the dried slices of Jerusalem artichoke into a dry powder, and the former is soaked with buffer solution, wherein cellulase and pectinase are originally added to help break down the cells and make the intracellular material go outside of the cell more easily; the buffer solution is pH 4-5.5 HAc—NaAc buffer solution, and the amount of the buffer solution is sufficient to completely soak the powder of Jerusalem artichoke; the power is soaked at 40° C.-55° C. for 0.5-1.5 h; the amount of cellulase and pectinase added is 0.1-0.5 wt %, and the mass ratio of the cellulase and pectinase is 1:1-3:1;

(3) Heating the treated solution in a hot water bath to deactivate enzymes and perform hot water extraction, and then obtain crude extracts of inulin; wherein the temperature of the hot water bath is 80° C.-100° C., and the time of the hot-water bath is 5-10 min.;

(4) Performing decoloring using activated carbon to decolor the crude extracts; wherein the decoloring operation comprises an addition of activated carbon powder of 5 grams per liter (g/L), a decoloring temperature of 60° C.-90° C. and a decoloring time of 5-20 min.;

(5) Allowing the extractive solution to clarify and removing impurities through a solid-liquid interface adsorption method by adding calcium hydroxide into the extractive solution and forming calcium phosphate precipitate; wherein the impurity removal operation comprises firstly adding calcium hydroxide into the extractive solution to adjust the pH to 10-12 and again adding phosphoric acid to adjust the pH to 8-10, and the clarification temperature is 40° C.-60° C.;

(6) Separating the extractive solution with an ultrafiltration membrane to obtain an inulin solution; wherein the ultrafiltration operation pressure is 0.01-0.1 MPa, the ultrafiltration temperature is 20° C.-40° C., and the standard molecular weight cut-off of ultrafiltration membrane is 1,000-10,000 Dalton;

(7) Vacuum concentrating the solution of inulin, and spray drying it to obtain high purity inulin.

Compared with prior art, the present invention has the following advantages:

(1) Compared with the conventional hot water extraction method, the present invention adopts bio-enzyme-assisted extraction, which reduces time for hot-water extraction from 30 min. to 5-10 min., and thus reduces energy consumption;

(2) In the extraction process of inulin, the biological method and the physical method are originally combined. In the present invention, the extraction efficiency of inulin is greatly improved through addition of cellulase and pectinase. Cellulase and pectinase mainly destroy β-1,4 glycosidic bonds and α-1,4 glycosidic bonds in plant cell walls to make the plant cell wall become fragile, thus making matter in the cell be more easily released. Compared with the conventional extraction method, the extraction rate of inulin is increased from 50% to 70%. Therefore the extraction rate of inulin is greatly increased;

(3) The present invention adopts the bio-enzyme-assisted extraction method. The whole extraction process is easy to operate, has reduced energy consumption with lower cost, and is more environmentally friendly compared with the high energy consumption microwave and ultrasonic extraction methods.

### DETAILED DESCRIPTION

The terminologies in the present invention have the standard meanings for those skilled in the field unless specified otherwise. The present invention will be described in further detail by combining specific embodiments and referring to data. It should be understood that those embodiments are only used for illustration purposes, and are not intended to limit the scope of the present invention in any way.

A bio-enzyme-assisted extraction method for inulin comprises the following steps:

(1) Adopting Jerusalem artichoke as a raw material, cleaning and slicing fresh Jerusalem artichoke, performing heat treatment by blanching with hot water to deactivate the polyphenol oxidase in the Jerusalem artichoke, and drying to obtain dried slices of Jerusalem artichoke; wherein the slices of Jerusalem artichoke are blanched at 80° C.-100° C. for 5-20 min. with hot water; the slices of Jerusalem artichoke are dried at 40° C.-75° C. for 3-9 h; the blanching temperature can be 80° C., 90° C., or 100° C.; the blanching time can be 5 min., 10 min., or 20 min.; the drying temperature can be 40° C., 52° C., or 75° C.; and the drying time can be 3 h, 6 h, or 9 h;

(2) Pulverizing the dried Jerusalem artichoke slices into dry powder, and soaking the powder with a buffer solution, wherein cellulase and pectinase are added to help break down cells and make the intracellular material go outside of the cell more easily; the buffer solution is a pH 4-5.5 HAc—NaAc buffer solution, and the amount of the buffer solution is sufficient to completely soak the powder of Jerusalem artichoke; the powder is soaked at 40° C.-55° C. for 0.5-1.5 h; the added amount of cellulase and pectinase is 0.1-0.5 wt %, and the mass ratio of cellulase and pectinase is 1:1-3:1; the soaking temperature can be 40° C., 50° C., or 55° C.; the soaking time can be 0.5 h, 1 h, or 1.5 h, the added amount of cellulase and pectinase can be 0.1 wt %, 0.25 wt %, or 0.5 wt %; and the mass ratio of cellulase and pectinase can be 1:1, 2:1, or 3:1;

(3) Heating the treated solution in a hot water bath to deactivate enzymes and performing a hot water extraction method to obtain a crude extract of inulin; wherein the temperature of the hot water bath is 80° C.-100° C., and can be 80° C., 90° C., or 10020 C.; the duration of the hot water bath is 5-10 min., and can be 5 min., 8 min., or 10 min.;

(4) Performing decoloring using activated carbon to decolor the crude extractive solution; wherein the decoloring condition comprises adding 5 g/L of activated carbon powder at a temperature of 60° C.-90° C. (can be 60° C., 80° C., or 90° C.) and a decoloring time of 5-20 min. (can be 5 min., 12 min., or 20 min.);

(5) Allowing the extractive solution to clarify and removing impurities through a solid-liquid interface adsorption method by adding calcium hydroxide into the extractive solution and forming calcium phosphate precipitate; wherein the impurity removal operation comprises firstly adding calcium hydroxide into the extractive solution to adjust the pH to 10-12 and adding phosphoric acid to adjust the pH to 8-10, and the clarification temperature is 40° C.-60° C.;

(6) Separating the extractive solution with an ultrafiltration membrane to obtain an inulin solution; wherein the ultrafiltration operation pressure is 0.01-0.1 MPa, ultrafiltration temperature is 20° C.-40° C., and standard molecular weight cutoff of the ultrafiltration membrane is 1,000-10,000 Dalton;

(7) Vacuum concentrating the solution of inulin, and spray drying it to obtain high purity inulin.

### Embodiment 1

A bio-enzyme-assisted extraction method using Jerusalem artichoke as a raw material comprises:

(1) Cleaning fresh rhizoma of Jerusalem artichoke and slicing it into 0.5 centimeter (cm) thick pieces; performing a blanching treatment in 80° C. hot water for 10 min. to deactivate polyphenol oxidase in the Jerusalem artichoke; and drying at 50° C. for 4 h to obtain dried slices of Jerusalem artichoke;

(2) Pulverizing the dried slices of Jerusalem artichoke into a dry powder having a particle size of 60 mesh, and soaking the dry powder in a pH 4.8 HAc—NaAc buffer solution, wherein the amount of the buffer solution is sufficient to completely soak the powder of Jerusalem artichoke; the powder is soaked at 50° C. for 0.5 h; cellulase and pectinase are added at amount of 0.2% to help break down cells and make the intracellular material go outside of the cell more easily, and the ratio of cellulase and pectinase is 1:1;

(3) Adjusting the solid-liquid ratio of the treated solution to 1:30, and heating in the solution in a 100° C. hot water bath for 5 min. to deactivate enzymes and carry out hot water extraction so as to obtain a crude extracted solution of inulin;

(4) Adding activated carbon powder into the crude extracted solution at amount of 5 g/L, and performing decoloring at 80° C. for 10 min.;

(5) Adding calcium hydroxide into the extracted solution of inulin to adjust the pH to 12, adding phosphoric acid to adjust the pH to 8, and maintaining the temperature at 60° C. to carry out clarification and impurity removal;

(6) Allowing the extracted solution of inulin, which has been decolored and impurity-removed, to pass through an ultrafiltration membrane with a molecular weight cut-off of 10,000 Dalton to remove macromolecule impurity, then allowing the permeate to pass through the ultrafiltration membrane with a molecular weight cut-off of 1,000 Dalton to remove small molecule impurities so as to obtain retentate as an inulin solution; wherein the ultrafiltration is operated at the pressure of 0.05 MPa, and the ultrafiltration temperature is 25° C.;

(7) Vacuum concentrating the solution of inulin and spray drying it to obtain high purity inulin.

The extraction rate of inulin is 70% after calculation.

### Embodiment 2

A bio-enzyme-assisted extraction method using Jerusalem artichoke as a raw material comprises:

(1) Cleaning fresh rhizoma of Jerusalem artichoke and slicing it into 0.5 cm thick pieces; performing a blanching treatment in 80° C. hot water for 10 min., deactivating polyphenol oxidase in the Jerusalem artichoke, and drying at 50° C. for 4 h to obtain dried slices of Jerusalem artichoke;

(2) Pulverizing the dried slices of Jerusalem artichoke into dry powder having a particle size of 60 mesh, and soaking the dry powder with a pH 5.2 HAc—NaAc buffer solution, wherein the amount of the buffer solution is sufficient to completely soak the powder of the Jerusalem artichoke; the powder is soaked at 45° C. for 0.5 h; cellulase and pectinase are added at an amount of 0.1% to help break down cells and make the intracellular material go outside of the cell more easily, and the ratio of cellulase and pectinase is 1:2;

(3) Adjusting the solid-liquid ratio of the treated solution to 1:30 and heating the solution in a 100° C. hot water bath for 5 min. to deactivate enzymes and carry out hot water extraction so as to obtain an inulin crude extract;

(4) Adding activated carbon powder into the crude extract at an amount of 5 g/L, and performing decoloring at 80° C. for 10 min.;

(5) Adding calcium hydroxide into the extracted solution of inulin to adjust the pH to 12, adding phosphoric acid to adjust the pH to 8, and maintaining the temperature at 60° C. to carry out clarification and impurity removal;

(6) Allowing the extracted solution of inulin, which has been decolored and impurity-removed, to pass through an ultrafiltration membrane with a molecular weight cut-off of 10,000 Dalton to remove macromolecule impurities, then allowing the permeate to pass through an ultrafiltration membrane with a molecular weight cut-off of 1,000 Dalton to remove small molecule impurities to obtain retentate as an inulin solution; wherein the ultrafiltration is operated at the pressure of 0.05 MPa, and the ultrafiltration temperature is 25° C.;

(7) Vacuum concentrating the solution of inulin, and spray drying it to obtain high purity inulin.

The extraction rate of inulin is 62% after calculation.

### Embodiment 3

A bio-enzyme-assisted extraction method using Jerusalem artichoke as a raw material comprises:

(1) Cleaning fresh rhizoma of Jerusalem artichoke, and slicing it into 0.5 cm thick pieces; performing a blanching treatment in 80° C. hot water for 10 min., deactivating polyphenol oxidase in the Jerusalem artichoke, and drying at 50° C. for 4 h to obtain dried slices of Jerusalem artichoke;

(2) Pulverizing the slices of dried Jerusalem artichoke into a dry powder having a particle size of 60 mesh, and soaking the dry powder with a pH 4 HAc—NaAc buffer solution, wherein the amount of the buffer solution is sufficient to completely soak the powder of Jerusalem artichoke; the powder is soaked at 40° C. for 20 min.; cellulase and pectinase are added at amount of 0.15% to help break down cells and make the intracellular material go outside of the cell more easily, and the ratio of cellulase and pectinase is 1:3;

(3) Adjusting the solid-liquid ratio of the treated solution to 1:30, and heating the solution in a 100° C. hot-water bath for 5 min. to deactivate enzymes and carry out hot water extraction so as to obtain an inulin crude extract;

(4) Adding activated carbon powder into the crude extract at amount of 5 g/L, and performing decoloring at 80° C. for 10 min.;

(5) Adding calcium hydroxide into the extracted solution of inulin to adjust the pH to 12, adding phosphoric acid to adjust the pH to 8, and maintaining the temperature at 60° C. to carry out clarification and impurity removal;

(6) Allowing the extracted solution of inulin, which has been decolored and impurity-removed, to pass through an ultrafiltration membrane with a molecular weight cut-off of 10,000 Dalton to remove macromolecule impurity, then allowing the permeate to pass through an ultrafiltration membrane with a molecular weight cut-off of 1,000 Dalton to remove small molecule impurities to obtain retentate as an inulin solution; wherein the ultrafiltration is operated at the pressure of 0.05 MPa, and the ultrafiltration temperature is 25° C.;

(7) Vacuum concentrating the solution of inulin, and spray drying it to obtain high purity inulin.

The extraction rate of inulin is 68% after calculation.

### Embodiment 4

An extraction method using Jerusalem artichoke as a raw material, which comprises the following steps:

(1) Cleaning fresh rhizome of Jerusalem artichoke and slicing it into 0.5 cm thick pieces; performing a blanching treatment in 80° C. hot water for 10 min., deactivating polyphenol oxidase in the Jerusalem artichoke, and drying at 50° C. for 4 h to obtain dried slices of Jerusalem artichoke;

(2) Pulverizing the dried slices of Jerusalem artichoke into a dry powder having a particle size of 60 mesh, and soaking the dry powder in 80° C. hot water for 50 min. in which the ratio of solid-liquid is 1:30 to obtain a crude extract of inulin;

(3) Adding activated carbon powder into the crude extract at amount of 5 g/L, and performing decoloring at 80° C. for 10 min.;

(4) Adding calcium hydroxide into the extracted solution of inulin to adjust the pH to 12, adding phosphoric acid to adjust the pH to 8, and maintaining the temperature at 60° C. to carry out clarification and impurity removal;

(5) Allowing the extracted solution of inulin, which has been decolored and impurity-removed, to pass through an ultrafiltration membrane with a molecular weight cut-off of 10,000 Dalton to remove macromolecule impurity, then allowing the permeate to pass through an ultrafiltration membrane with a molecular weight cut-off of 1,000 Dalton to remove small molecule impurities to obtain retentate as an inulin solution; wherein the ultrafiltration is operated at the pressure of 0.05 MPa, and the ultrafiltration temperature is 25° C.;

(6) Vacuum concentrating the solution of inulin, and spray drying it to obtain high purity inulin.

The extraction rate of inulin is 52% after calculation.

1. A bio-enzyme-assisted extraction method for inulin, comprising:
extracting a pretreated dry powder of Jerusalem artichoke using a hot water extraction method to obtain crude inulin extract;
decoloring the extract;
removing impurities from the extract;
purifying the extract with an ultrafiltration membrane;
vacuum concentrating the extract; and
spray drying the extract to obtain inulin;
wherein the dry powder of Jerusalem artichoke is soaked with a pH 4-5.5 HAc—NaAc buffer solution in which cellulose and pectinase of 0.1-0.5 wt % are added before hot water extraction, the mass ratio of cellulase and pectinase being 1:1-3:1 and the dry powder soaking at 40° C.-55° C. for 0.5-1.5 hours.

2. The bio-enzyme-assisted extraction method for inulin according to claim 1, wherein the dry powder of Jerusalem artichoke is pretreated by cleaning and slicing fresh Jerusalem artichoke, blanching the artichoke slices at 80° C.-100° C. with hot water for 5-20 minutes, drying the artichoke slices to obtain dried slices, and pulverizing the dried slices to obtain a dry powder of Jerusalem artichoke.

3. The bio-enzyme-assisted extraction method for inulin according to claim 1, wherein decoloring and impurity removal comprises adding activated carbon powder at amount of 5 g/L, decoloring at 60° C.-90° C. for 5-20 minutes, adjusting the pH to 10-12 with calcium hydroxide, then adjusting the pH to 8-10 with phosphoric acid, and maintaining the temperature at 40° C.-60° C. to carry out clarification and impurity removal.

4. The bio-enzyme-assisted extraction method for inulin according to claim 1, wherein the standard molecular weight cut-off of the ultrafiltration membrane is 1,000-10,000 Dalton, the operation pressure during filtration is 0.01-0.1 MPa, and the temperature during filtration is 20° C.-40° C.

5. The bio-enzyme-assisted extraction method for inulin according to claim 1, wherein the hot water extraction temperature is 80° C.-100° C. and the extraction time is 5-10 minutes.
